(19) United States
(12) Patent Application Publication
(10) Pub. No.: US 2020/0283323 A1
(43) Pub. Date: Sep. 10, 2020

(54) INLINE DEWATERING SYSTEM

(71) Applicants: Joseph W. DENDEL, Otsego, MI (US); Roger TYRIA, Plainwell, MI (US); Deric HAUSMANN, Indian Harbour Beach, FL (US); Johannes Gerardus Maria VERWATER, Merritt Island, FL (US)

(72) Inventors: Joseph W. DENDEL, Otsego, MI (US); Roger TYRIA, Plainwell, MI (US); Deric HAUSMANN, Indian Harbour Beach, FL (US); Johannes Gerardus Maria VERWATER, Merritt Island, FL (US)

(21) Appl. No.: 16/882,874

(22) Filed: May 26, 2020

Related U.S. Application Data
(63) Continuation of application No. 14/604,184, filed on Jan. 23, 2015.
(60) Provisional application No. 61/930,708, filed on Jan. 23, 2014.
(60) Provisional application No. 62/055,294, filed on Sep. 25, 2014.
(60) Provisional application No. 62/085,839, filed on Dec. 1, 2014.

(51) Int. Cl. C02F 11/121

(52) U.S. Cl. CPC C02F 11/121; C02F 11/125

(57) ABSTRACT

An inline thickener including a cylinder, a wiper inside the cylinder and rotating relative thereto for cleaning an interior surface of the cylinder, an outer housing, a sludge inlet for inserting sludge under pressure into a first end of the cylinder, a sludge outlet at a second end of the cylinder, and a filtrate outlet for allowing a portion of liquid removed from the sludge to exit the inline thickener. The pressure of the sludge inlet, the sludge outlet and the filtrate outlet are measured and controlled to allow for a selected percentage of the liquid in the sludge entering the inline thickener to be removed from the sludge. The sludge is not mechanically compacted within the inline thickener.

### CROSS REFERENCE TO RELATED APPLICATIONS

This is a continuation of U.S. patent application Ser. No. 14/604 184, filed Jan. 23, 2015, which claims the benefit of U.S. Provisional Applications U.S. Ser. No. 61/930 708, filed on Jan. 23, 2014, U.S. Ser. No. 62/085 839, filed on Dec. 1, 2014, and U.S. Ser. No. 62/055 294, filed on Sep. 25, 2014, the disclosures of all of which are hereby incorporated by reference in its entirety.

### FIELD OF THE INVENTION

The present invention concerns a liquid extraction system, and more particularly relates to an inline dewatering system including an inline thickener and an inline press.

### BACKGROUND OF THE INVENTION

Apparatus for feeding, compressing, liquid extraction, washing and chemical treatment of sludge, slurries or other wet materials are well known. Such equipment finds particular application in the pulp and paper industry, waste water treatment, mineral processing, agriculture, food processing, fisheries, breweries, wineries, chemical processing, oil and tar sands industry, etc.

An improved apparatus is desired for feeding, compressing, liquid extracting, washing and chemical treating of the sludge, slurries or other wet materials.

### SUMMARY OF THE INVENTION

A first aspect of the present invention is to provide an inline thickener including a cylinder, a wiper inside the cylinder and rotating relative thereto for cleaning an interior surface of the cylinder, an outer housing, a sludge inlet for inserting sludge under pressure into a first end of the cylinder, a sludge outlet at a second end of the cylinder, and a filtrate outlet for allowing a portion of liquid removed from the sludge to exit the inline thickener. The pressure of the sludge inlet, the sludge outlet and the filtrate outlet are measured and controlled to allow for a selected percentage of the liquid in the sludge entering the inline thickener to be removed from the sludge. The sludge is not mechanically compacted within the inline thickener.

Another aspect of the present invention is to provide a method of removing a selected percentage of liquid from sludge while maintaining a path for the selected percentage of the liquid removed from free of blockage. The method comprises providing an outer housing, providing a cylinder within the outer housing, positioning a wiper inside the cylinder, rotating the wiper relative to the cylinder thereby cleaning an interior surface of the cylinder, inserting sludge under pressure into a first end of the cylinder, forcing the sludge through an interior of the cylinder, removing the selected percentage of liquid from the sludge passing through the cylinder, outletting the sludge with the selected percentage of the liquid removed therefrom at a second end of the cylinder through a sludge outlet, outletting the selected percentage of the liquid removed from the sludge through a filtrate outlet, and measuring and controlling the pressure of the sludge inlet, the sludge outlet and the filtrate outlet to control the selected percentage of the liquid in the sludge removed from the sludge. The sludge is not mechanically compacted within the inline thickener.

### BRIEF DESCRIPTION OF DRAWINGS

FIG. 1 is a schematic view of a liquid extraction system including an inline thickener of the present invention.

FIG. 2 is a perspective view of the inline thickener of the present invention.

FIG. 3A is a cross-sectional side view of a first end of the inline thickener of the present invention taken along line IIIA-IIIA of FIG. 2.

FIG. 3B is a cross-sectional side view of a second end of the inline thickener of the present invention taken along line IIIB-IIIB of FIG. 2.

FIG. 4 is an exploded view of a filter screen and a wiper of the inline thickener of the present invention.

FIGS. 5-9 illustrate a second embodiment of the inline thickener of the present invention, with FIG. 9 illustrating a method of disassembling the inline thickener for cleaning.

FIG. 10 is a perspective view of a wiggle plate assembly of a third embodiment of the inline thickener of the present invention.

FIG. 11 is a side view of the wiggle plate assembly of the third embodiment of the inline thickener of the present invention.

FIG. 12 is a top view of the wiggle plate assembly of the third embodiment of the inline thickener of the present invention.

FIG. 13 is a perspective view of a mount plate of the wiggle plate assembly of the third embodiment of the inline thickener of the present invention.

FIG. 14 is a front view of the mount plate of the wiggle plate assembly of the third embodiment of the inline thickener of the present invention.

FIG. 15 is a side view of the mount plate of the wiggle plate assembly of the third embodiment of the inline thickener of the present invention.

FIG. 16 is a perspective view of a wiggle plate of the wiggle plate assembly of the third embodiment of the inline thickener of the present invention.

FIG. 17 is a front view of the wiggle plate of the wiggle plate assembly of the third embodiment of the inline thickener of the present invention.

FIG. 18 is a side view of the wiggle plate of the wiggle plate assembly of the third embodiment of the inline thickener of the present invention.

FIG. 19 is a cross-sectional view of the wiggle plate of the wiggle plate assembly of the third embodiment of the inline thickener of the present invention taken along line XIX-XIX of FIG. 17.

FIG. 20 is an enlarged cross-sectional view of the wiggle plate of the wiggle plate assembly of the third embodiment of the inline thickener of the present invention taken from area C of FIG. 19.

FIG. 21 is an enlarged cross-sectional view of the wiggle plate of the wiggle plate assembly of the third embodiment of the inline thickener of the present invention taken from area D of FIG. 18.

FIG. 22 is an enlarged view of the wiggle plate of the wiggle plate assembly of the third embodiment of the inline thickener of the present invention taken from area B of FIG. 17.

FIG. 23 is an enlarged perspective view of the wiggle plate of the wiggle plate assembly of the third embodiment of the inline thickener of the present invention taken from area B of FIG. 17.

FIG. 24 is a schematic view of a dewatering system of the present invention.

### DETAILED DESCRIPTION OF PREFERRED EMBODIMENTS

It is to be understood that the invention as described herein may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present invention relates to an apparatus and method for extracting liquid from a humid mass (e.g., sludges and slurries), as those used or produced in the pulp and paper industry, waste water treatment plants, agricultural, food and beverage industries, etc. The present invention can be used to remove a portion of liquid from the humid mass to produce a waste solid that is easy to treat for disposal or remove a portion of liquid from the humid mass for other purposes.

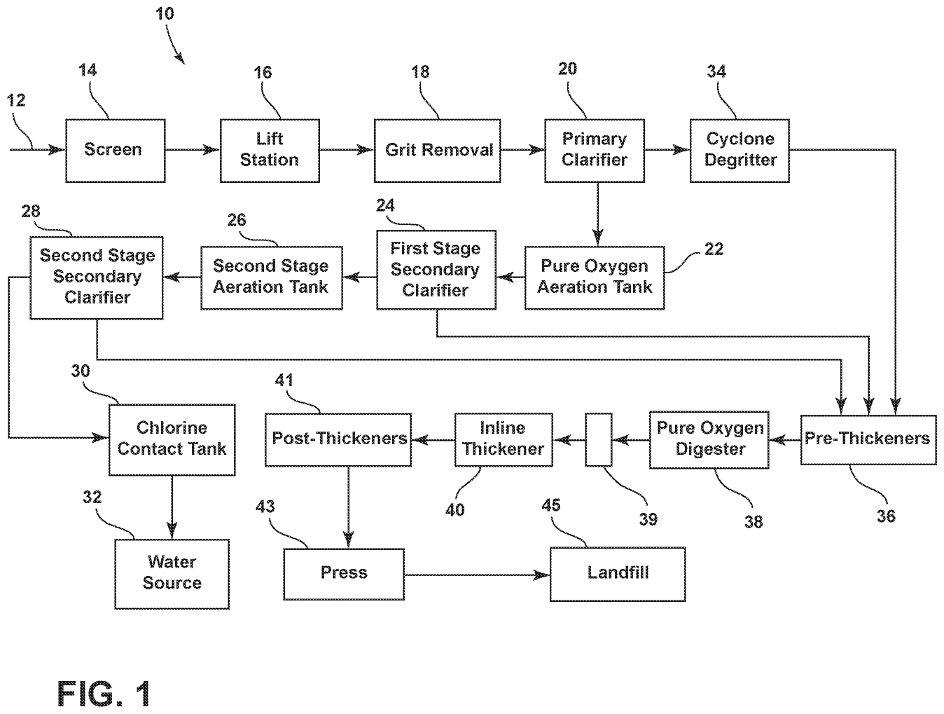

The reference number 10 (FIG. 1) generally designates a system for extracting liquid from a mass for purifying waste water. The illustrated system 10 for extracting liquid from a mass comprises a plurality of elements or machines that can remove a portion of waste material from the mass or prepare the mass for removal of a portion of waste material as the mass travels through the system 10. The mass enters the system 10 at an input 12 and is passed through at least one screen 14 (e.g., coarse screens and/or fine screens) and then at least one lift station 16. Screens 14 and lift stations 16 are well known to those skilled in the art and are used to remove large solid material (e.g., rags, paper, plastics, and metals) from the mass. Although not illustrated, the mass can also be passed through at least one comminutor and/or at least one grinder. The mass then is subjected to aerated grit removal at a grit remover 18 for removing grit (e.g., sand, gravel, cinder, or other heavy solid materials). Many types of grit removers 18 exist and are well known to those skilled in the art. For example, the grit remover 18 can include aerated grit chambers, vortex-type (paddle or jet induced vortex) grit removal systems, detritus tanks (short-term sedimentation basins), horizontal flow grit chambers (velocity-controlled channel), and hydrocyclones (cyclonic inertial separation). The mass with the grit removed is then passed to at least one primary clarifier 20, wherein a portion of the solid material in the mass is settled to the bottom of each primary clarifier 20 and subsequently removed to at least one cyclone degritter 34. The portion of the solid material in the mass that is settled to the cyclone degritter 34 is called “waste sludge.” The waste sludge, after passing through the cyclone degritter 34, is passed to at least one pre-thickener 36.

In the illustrated system, the portion of the mass that does not have the waste sludge removed therefrom in the at least one primary clarifier 20 is then passed to at least one pure oxygen aeration tank 22, wherein oxygen is added to the mass in order to increase the speed of the mass through the system. The mass then passes to at least one first stage second clarifier 24, where once again the waste sludge (i.e., the solid material in the mass that is settled to the bottom of the first stage second clarifier 24) is removed therefrom and passed directly to the at least one pre-thickener 36. The mass, after passing through the at least one first stage second clarifier 24, is passed to at least one second stage aeration tank 26 wherein the mass is further aerated. The mass is then passed to at least one second stage secondary clarifier 28, where once again the waste sludge (i.e., the solid material in the mass that is settled to the bottom of the second stage secondary clarifier 28) is removed therefrom and passed directly to the at least one pre-thickener 36. The mass, after passing through the at least one second stage secondary clarifier 28, is ready to be passed to a water source 32 (e.g., river) after passing through a chlorine contact tank 30 to remove or neutralize any fecal coliform bacteria in the mass (which is almost pure liquid at this point).

In the illustrated example, the waste sludge is passed to the pre-thickener 36 to be finally processed to remove all liquid from the waste sludge. Pre-thickeners 36 are well known to those skilled in the art and are used to further remove liquid from the waste sludge (e.g., gravity thickener, centrifugal thickener, gravity belt thickener and rotary drum thickeners). After passing through the pre-thickener 36, the waste sludge is passed to a post-thickener 41 after passing through a pure oxygen digester 38 and an inline thickener 40 of the present invention. The post-thickeners 41 are well known to those skilled in the art and are used to further remove liquid from the waste sludge (e.g., gravity thickener, centrifugal thickener, gravity belt thickener and rotary drum thickeners). The inline thickener 40 and the pure oxygen digester 38 can be placed in any order between the pre-thickener 36 and the post-thickener 41. The pure oxygen digester 38 adds oxygen to the waste sludge to destruct degradable organic components and reduce pathogenic organisms in the waste sludge. The inline thickener 40 is discussed in more detail below. After the waste sludge passes through the post-thickener 41, the waste sludge passes through a press 43. The press 43 can be any press known to those skilled in the art. For example, the press 43 can be a belt filter press or the rotary fan press as disclosed in U.S. Pat. No. 7,895,943, the entire contents of which are hereby incorporated herein by reference. All of the liquid removed from the pre-thickeners 36, the inline thickener 40, the post-thickeners 41 and the presses 43 can be moved to the chlorine contact tank 30 and the solid portion of the waste sludge removed from the press 43 can be placed in a landfill 45. It is contemplated that the pre-thickener 36 and the post-thickener 41 could be the inline thickener 40 (either with or without any further inline thickeners 40).

FIG. 1 illustrates a particular design of a system for extracting liquid from a mass for purifying waste water. However, the system for extracting liquid from a mass can be used to purify waste water in many different configurations using only some of the machines as illustrated in FIG. 1, using more than the machines as illustrated in FIG. 1 and/or substituting different machines for those illustrated in FIG. 1. Furthermore, the inline thickener 40 of the present invention can be used in any system for thickening a mass of solid and liquid (e.g., those used or produced in the pulp and paper industry, waste water treatment plants, agricultural, food and beverage industries, etc.) The inline thickener 40 receives the mass therein, with the mass being forced into and through the inline thickener 40 by pressure from a pump 39. The pump 39 is illustrated in FIG. 1 as being directly before the inline thickener 40 in the system 10. However, it is contemplated that the pump 39 could be located anywhere before the input 12 to the inline thickener 40.

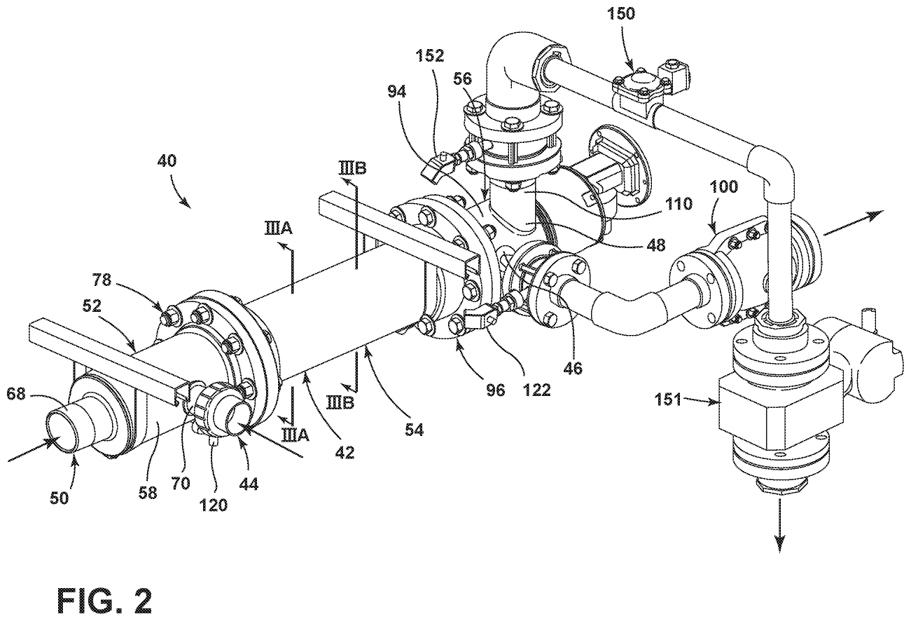

The illustrated inline thickener 40 (FIG. 2) removes a selected portion of the liquid from the mass. The inline thickener 40 includes a liquid removal assembly 42 wherein the selected portion of the liquid is removed from the mass. The liquid removal assembly 42 has a mass input 44 for receiving mass under pressure, a thickened mass output 46 and a filtrate output 48. During use, the mass enters the inline thickener 40 and a portion of the liquid in the mass is removed therefrom. The portion of the liquid removed from the mass exits the inline thickener 40 through the filtrate output 48 and the mass with the portion of liquid removed therefrom exits the inline thickener 40 through the thickened mass output 46. The inline thickener 40 can also include a filtrate input 50 as described in more detail below.

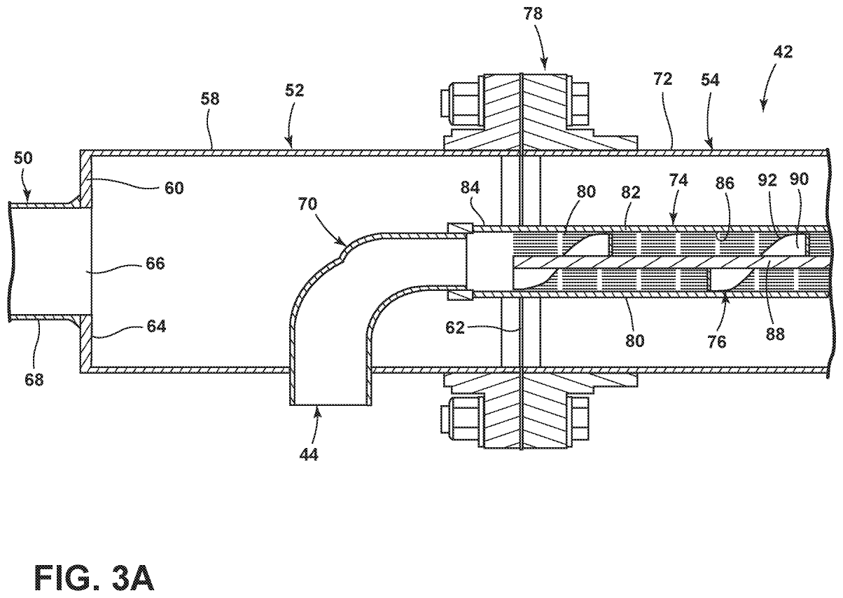

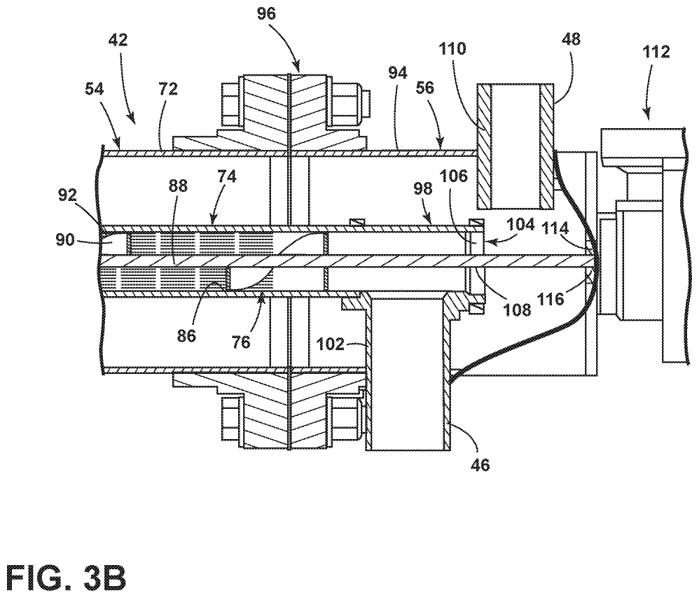

In the illustrated example, the inline thickener 40 receives the mass through the mass input 44 in an input section 52 of the liquid removal assembly 42, removes a portion of the liquid from the mass in a liquid removal section 54 of the liquid removal assembly 42, and outputs the liquid removed from the mass and the mass with the liquid removed therefrom through the filtrate output 48 and the thickened mass output 46 in an output section 56 of the liquid removal assembly 42. The input section 52 (FIG. 3A) of the liquid removal assembly 42 includes an input outer cylinder 58 having a first end 60 and a second end 62. A first end plate 64 is located at the first end 60 of the input outer cylinder 58, with the first end plate 64 having a centrally located opening 66. The filtrate input 50 is a tube 68 connected to the first end plate 64. A filtrate liquid can be inserted through the tube 68 and through the centrally located opening 66 to enter the input section 52. It is contemplated that the filtrate input 50 can be closed or have a cap on the tube 68 to prevent passage of liquid into or out of the input section 52 through the filtrate input 50 as described in more detail below. The mass input 44 comprises an elbow tube 70 that enters the input outer cylinder 58 radially and then curves to extend axially along the input outer cylinder 58 towards the second end 62 thereof. A central axis of the elbow tube 70 extending axially along the input outer cylinder 58 is substantially located along a central axis of the input outer cylinder 58. The liquid removal section 54 of the liquid removal assembly 42 is connected to the input section 52 of the liquid removal assembly 42.

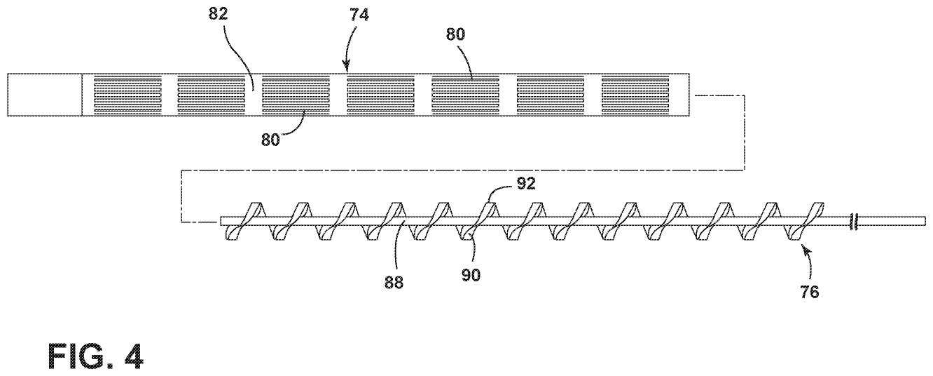

In the illustrated example, the portion of the liquid is removed from the mass in the liquid removal section 54 of the liquid removal assembly 42 of the inline thickener 40. The liquid removal section 54 includes an outer cylinder 72, a screen cylinder 74 and a wiper 76. The outer cylinder 72 of the liquid removal section 54 has substantially the same diameter as the input outer cylinder 58 of the input section 52 of the liquid removal assembly 42. A clamp assembly 78 connects the outer cylinder 72 of the liquid removal section 54 to the input outer cylinder 58 of the input section 52 of the liquid removal assembly 42. The screen cylinder 74 (FIG. 4) extends along a central axis of the outer cylinder 72 of the liquid removal section 54. The screen cylinder 74 includes a plurality of openings 80 therethrough. In the illustrated example, the openings 80 comprise a plurality of rings of straight parallel aligned slots extending through a wall 82 of the screen cylinder 74. However, it is contemplated that the opening 80 can be formed of a plurality of small circular or non-circular holes, a plurality of arcuate slots or any other opening that will allow liquid to pass therethrough but prevent most of the solid material of the mass from passing therethrough (e.g., helical slots). The screen cylinder 74 is fixed at a first end 84 to the elbow tube 70 such that the mass entering the liquid removal assembly 42 will pass through the elbow tube 70 and directly into the center or interior area of the screen cylinder 74. As discussed in more detail below, a selected portion of the liquid in the mass will pass through the openings 80 in the screen cylinder 74 while the remainder of the mass will pass through the center of the screen cylinder 74 from the elbow tube 70 to the thickened mass output 46 in the output section 56 of the liquid removal assembly 42.

The illustrated wiper 76 extends along the center of the screen cylinder 74 and forms a path for the mass traveling through the screen cylinder 74 and scrapes against an inner surface 86 of the screen cylinder 74 to keep the inner surface 86 clean to allow the liquid removed from the mass to pass therethrough. The wiper 76 includes an axle 88 and a helical scraper fin 90. The helical scraper fin 90 extends radially from the axle 88 and an outer end 92 of the helical scraper fin 90 abuts against the inner surface 86 of the screen cylinder 74. The helical scraper fin 90 forms a path through the screen cylinder 74 for the mass to pass. The helical scraper fin 90 has a consistent shape (i.e., the width of each winding of the fin has the same distance) such that the mass traveling through the screen cylinder 74 is not compacted because of the helical scraper fin 90. However, as discussed in more detail below, the thickened mass output 46 includes a valve 100 for building pressure within the screen cylinder 74 to force the selected portion of the liquid from the mass and through the openings 80 in the screen cylinder 74. It is contemplated that the outer end 92 of the helical scraper fin 90 can be formed of a rigid material (e.g., metal or polymer) or could be flexible (e.g., rubber). A second end 98 of the screen cylinder 74 extends into the output section 56 of the liquid removal assembly 42.

In the illustrated example, the output section 56 of the liquid removal assembly 42 (see FIG. 3B) includes the filtrate output 48 and the thickened mass output 46. The output section 56 includes an output outer cylinder 94 connected to the outer cylinder 72 of the liquid removal section 54 by a clamp assembly 96. The thickened mass output 46 is a tube 102 extending radially through the output outer cylinder 94 and connected radially to the second end 98 of the screen cylinder 74 to allow the mass that passes through the center of the screen cylinder 74 to pass through the tube 102 and out of the liquid removal assembly 42 through the thickened mass output 46. A second terminal end 104 of the screen cylinder 74 includes a seal plate 106 to prevent the mass from passing therethrough. The seal plate 106 includes a central hole 108 to allow the axle 88 of the wiper 76 to pass therethrough. The filtrate output 48 includes a tube 110 extending radially through the output outer cylinder 94. A motor assembly 112 having a motor (not shown) is connected to a second end of the output outer cylinder 94. The output outer cylinder 94 includes a second end terminal seal wall 114 to prevent the selected portion of the liquid removed from the mass from passing therethrough. The second end terminal seal wall 114 includes a central opening 116 to allow the axle 88 rotated by the motor of the motor assembly 112 to pass therethrough. The screen cylinder 74 is held in position within the liquid removal assembly 42 by the elbow tube 70 (which is connected to the input outer cylinder 58) and the tube 94 (which is connected to the output outer cylinder 94). It is further contemplated that the screen cylinder 74 could be maintained in position by struts extending between the screen cylinder 74 and the outer cylinder 72. While the wiper 76 is illustrated as being rotatable relative to the screen cylinder 74, it is contemplated that the screen cylinder 74 could be rotated while the wiper 76 remains stationary.

In use, the mass is inputted into the liquid removal assembly 42 through the mass input 44, passes through the elbow tube 70, passes through the screen cylinder 74 and exits the liquid removal assembly 42 through the tube 102 of the thickened mass output 46. As illustrated in FIG. 2, the thickened mass output 46 includes the valve 100. The valve 100 is selectively opened and closed (partially or fully) to allow the mass with the selected portion of liquid removed therefrom to pass therethrough. The mass input 44 includes a mass input pressure sensor 120 for sensing a pressure of the mass entering the liquid removal assembly 42, with the pump 39 applying pressure to the mass. The thickened mass output 46 includes a mass output pressure sensor 122 for sensing the pressure of the mass with the selected portion of liquid removed therefrom exiting the liquid removal assembly 42. By adjusting the valve 100, the pressure differential between the mass entering the liquid removal assembly 42 and the mass exiting the liquid removal assembly 42 can be maintained or adjusted to be at a desired level. It is contemplated that the valve 100 could be any valve (e.g., pinch) or any control arm or any other method of limiting the amount of mass passing therethrough. Furthermore, in use, the filtrate input 50 is closed.

In the illustrated example as shown in FIG. 2, the filtrate output 48 includes a control arm 150 for selectively allowing a portion (or all) of the liquid removed from the mass to pass therethrough. The control arm 150 is selectively opened and closed (partially or fully) to allow the selected portion of liquid removed from the mass to pass therethrough. The filtrate output 48 includes a filtrate output pressure sensor 152 for sensing the pressure of the liquid removed from the mass exiting the liquid removal assembly 42. By adjusting the control arm 150, the pressure of the liquid removed from the mass can be controlled to be at a desired level. It is contemplated that the control arm 150 could be any valve (e.g., pinch) or any control arm or any other method of limiting the amount of liquid passing therethrough. Furthermore, in use, the filtrate input 50 is closed. Through use of the control arm 150, the amount of liquid removed from the mass can be controlled. For example, if the pressure of the liquid exiting the filtrate output 48 is about equal to the pressure of the mass exiting the thickened mass output 46, almost no liquid will be removed from the mass as the mass passes through the screen cylinder 74. As the pressure of the liquid exiting the filtrate output 48 is lessened compared to the pressure of the mass exiting the thickened mass output 46, more liquid will be removed from the mass within the screen cylinder 74 because of the pressure differential between the outside of the screen cylinder 74 (as controlled by the control arm 150) and the inside of the screen cylinder 74 (as controlled by the valve 100). Therefore, a control system for the inline thickener 40 can control the amount of liquid removed from the mass as the mass passes through the inline thickener 40. The inline thickener 40 can also include a flow meter 151 for measuring the flow of filtrate out of the inline thickener 40 (with the flow meter reading being used to control the filtrate output (in addition to or as a substitute to control from the valve 150)). The filtrate input 50 can be opened to allow the area outside of the screen cylinder 74 to be filled with a liquid to easier set the pressure of the area outside of the screen cylinder 74 or filtrate (or cleaning fluid) can be inputted into the liquid removal assembly 42 through the filtrate input 50 to clean the liquid removal assembly 42 and the screen cylinder 74 by forcing the filtrate (or cleaning fluid) through the openings 80 in the screen cylinder 74 from outside the screen cylinder 74.

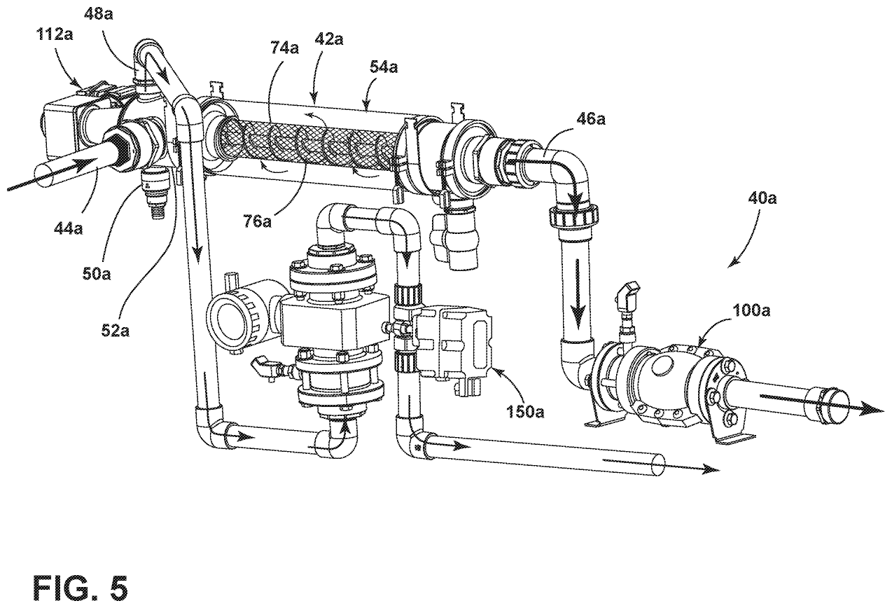

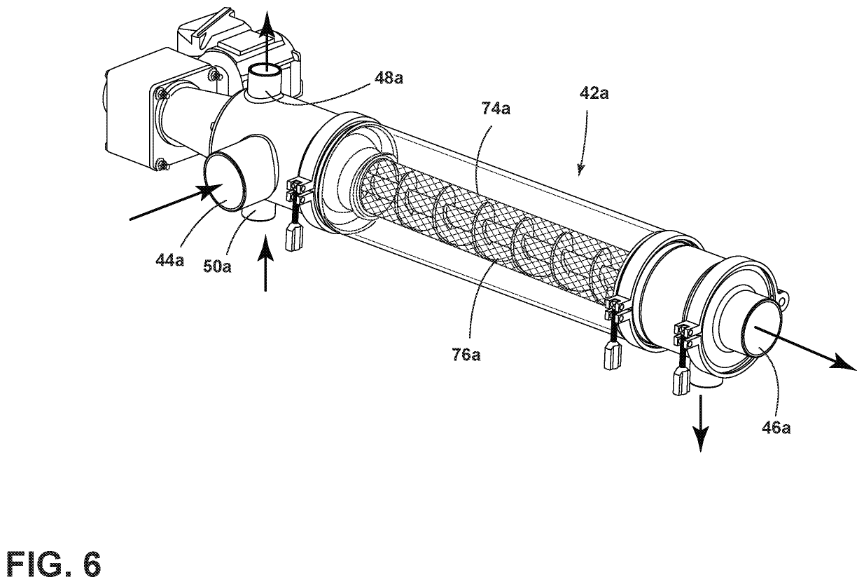

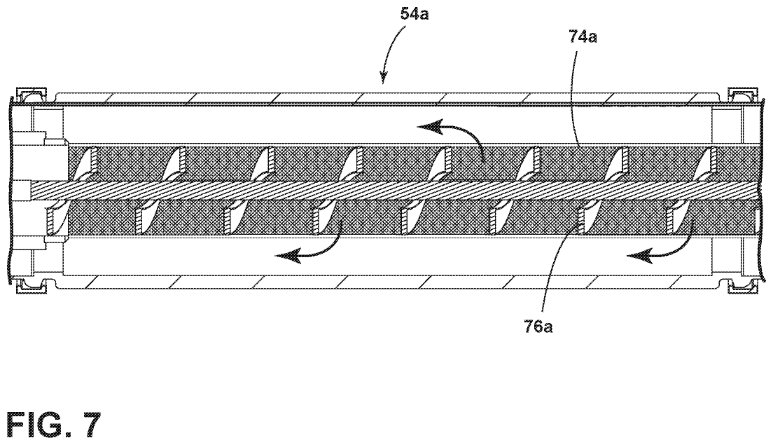

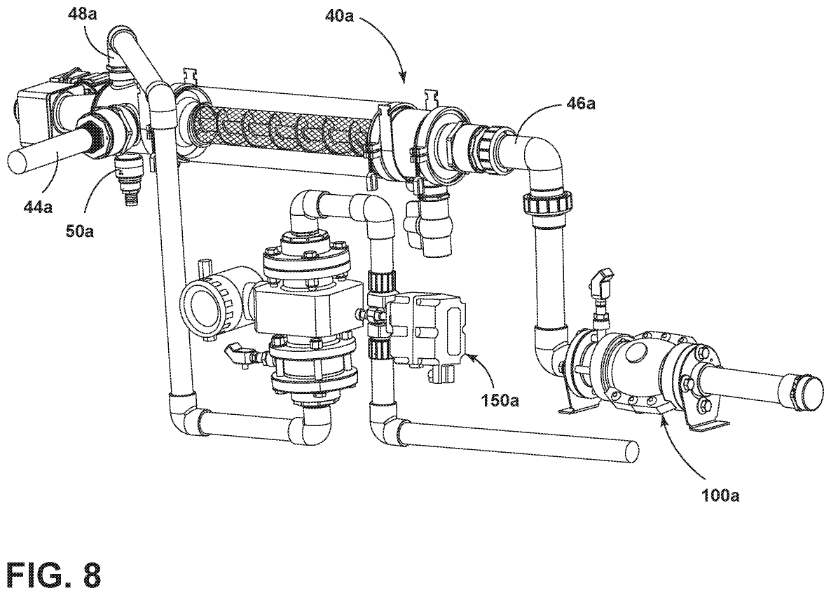

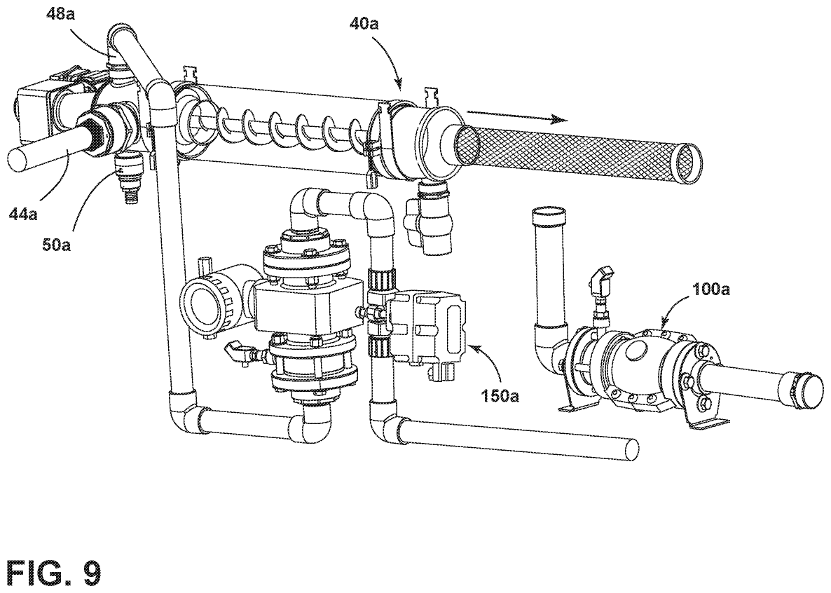

FIGS. 5-9 illustrate a second embodiment of the inline thickener 40a, with similar parts in the second embodiment of the inline thickener 40a having the same reference number as the first embodiment of the inline thickener 40, except with the letter “a” being added to the reference number for the second embodiment of the inline thickener 40a. One of the differences between the first embodiment of the inline thickener 40 and the second embodiment of the inline thickener 40a is that the second embodiment of the inline thickener 40a includes the filtrate output 48a adjacent the mass input 44a instead of adjacent the thickened mass output 46a. It is contemplated that the filtrate output 48 can be located anywhere along the length of the liquid removal assembly 42a.

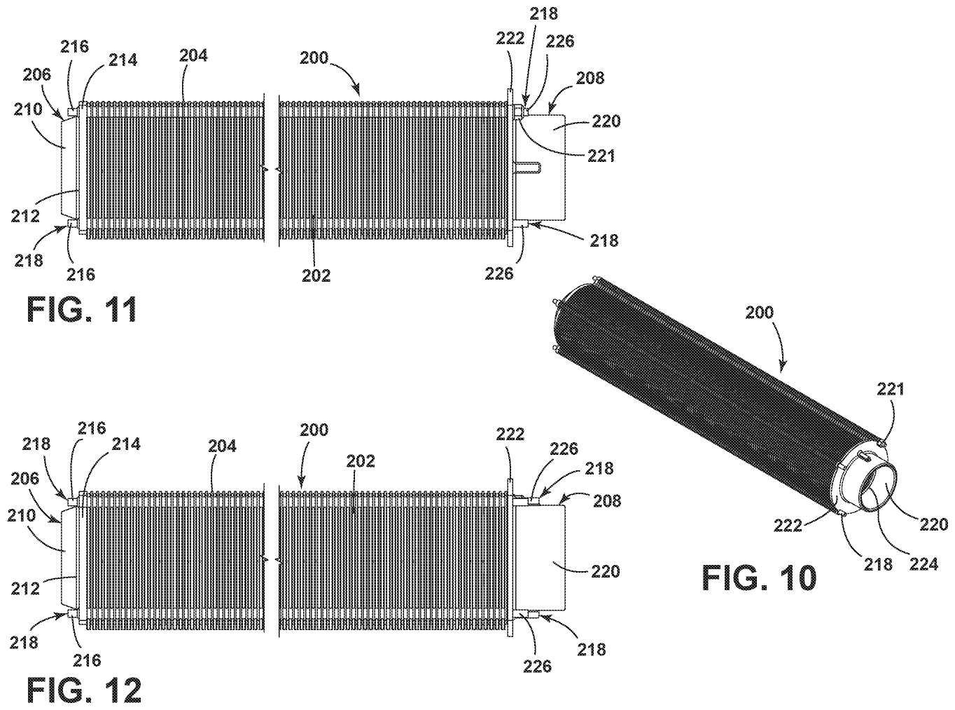

FIGS. 10-12 illustrate a wiggle plate assembly 200 to be used in a third embodiment of the inline thickener. The wiggle plate assembly 200 replaces the screen cylinder 74 used in the first embodiment of the inline thickener. All other elements of the first embodiment of the inline thickener can be used in the third embodiment of the inline thickener. The wiggle plate assembly 200 includes a plurality of alternating wiggle plates 202 and mount plates 204 sandwiched between an inlet tube 206 and an outlet tube 208. The plurality of alternating wiggle plates 202 and mount plates 204 form a virtual cylinder accepting the wiper 76 therein. The inlet tube 206 is fixed to the elbow tube 70 such that the mass entering the liquid removal assembly 42 will pass through the elbow tube 70 and directly into the virtual cylinder of the wiggle plate assembly 200. As discussed in more detail below, a selected portion of the liquid in the mass will pass radially through the virtual cylinder of the wiggle plate assembly 200 between the wiggle plates 202 and the mount plates 204 while the remainder of the mass will pass through the center of the wiggle plate assembly 200 from the elbow tube 70 to the thickened mass output 46 in the output section 56 of the liquid removal assembly 42.

In the illustrated example, the inlet tube 206 and the outlet tube 208 form an entrance and an exit to the virtual cylinder of the wiggle plate assembly 200. The inlet tube 206 includes a tapered cylinder 210, with a wider end 212 of the tapered cylinder 210 being connected to an inlet connection plate 214. The inlet connection plate 214 is circular and has a centrally located circular opening surrounded by the tapered cylinder 210. The inlet connection plate 214 includes a plurality of holes for accepting a first end 216 of elongate fasteners 218 therethrough. The elongate fasteners 218 connect the inlet tube 206 to the outlet tube 208. The outlet tube 208 includes a cylinder 220 connected to an outlet connection plate 222. The outlet connection plate 222 is circular and has a centrally located circular opening 224 surrounded by the cylinder 220. The outlet connection plate 222 includes a plurality of holes for accepting a second end 226 of the elongate fasteners 218 therethrough. The elongate fasteners 218 can be fixed in locations by nuts 221 (only one nut 221 is shown in FIGS. 10 and 11, but a nut 221 could be located on each first end 216 and second end 226 of the elongate fasteners 218). The elongate fasteners 218, along with connecting the inlet tube 206 to the outlet tube 208, also fix the mount plates 204 and the wiggle plates 202 in position.

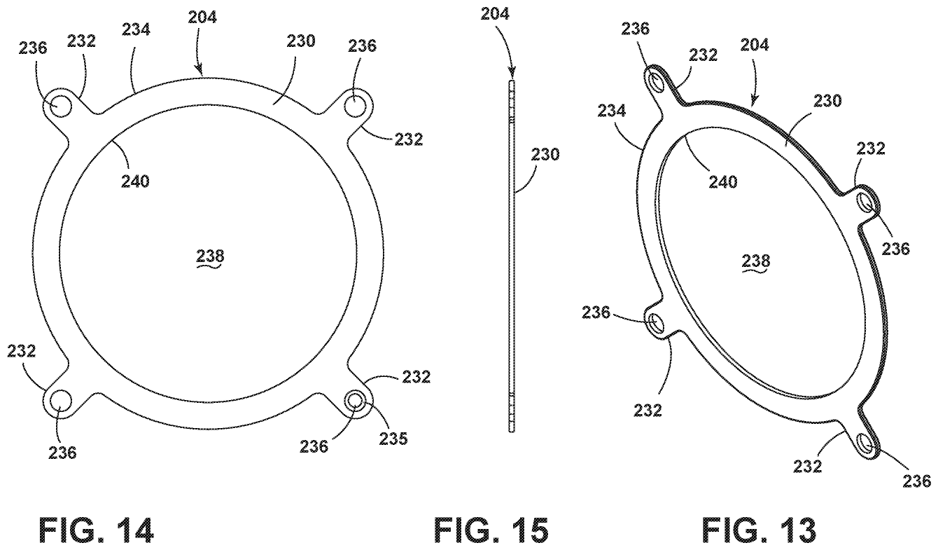

The illustrated mount plates 204 (FIGS. 13-15) maintain the wiggle plates 202 of the wiggle plate assembly 200 in position. The mount plates 204 each include a circular flat disc 230 having a plurality of planar ears 232 extending radially from an outside edge 234 of the circular flat disc 230. Each planar ear 232 has a hole 236 therethrough. The holes 236 each have a washer 235 fixed therein (only one washer 235 is shown in FIGS. 13-15, but a nut washer could be located in each hole 236). The elongate fasteners 218 extend through the washers 235 in the holes 236 and the washers 235 are locked into position in a fixed location along the elongate fasteners 218. The washers 235 can be fixed in location into position on the elongate fasteners 218 through an interference fit and/or by using an additional fastener (e.g., adhesive). It is also contemplated that the elongate fasteners 218 could be locked into positon within the holes 236 themselves by an interference fit and/or by using an additional fastener (e.g., adhesive). The circular flat disc 230 includes a central opening 238, with an inside edge 240 of the circular flat disc 230 at the central opening 238 forming a portion of the virtual cylinder of the wiggle plate assembly 200. The central opening 238 has a diameter such that the outer end 92 of the wiper 76 can engage the inside edge 240 to clear the inside edge 240 in the same manner that the wiper 76 cleans the screen cylinder 74 of the first embodiment of the inline thickener.

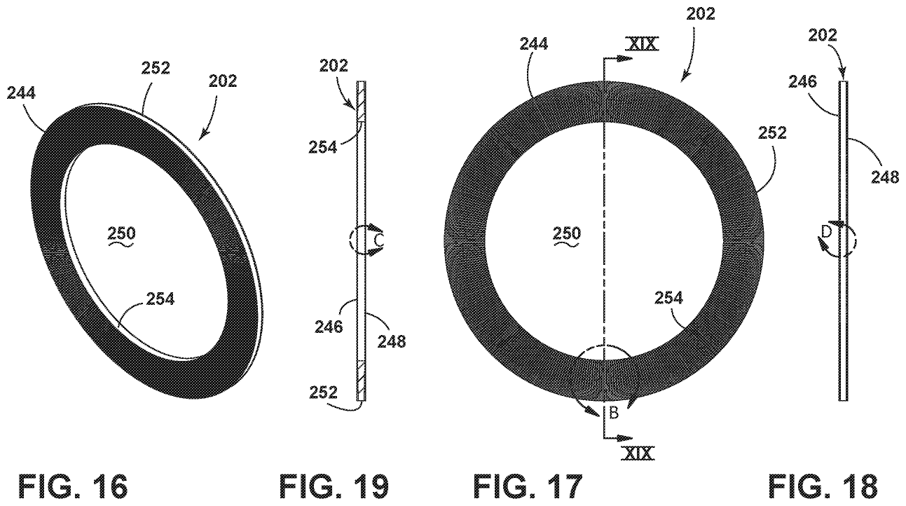

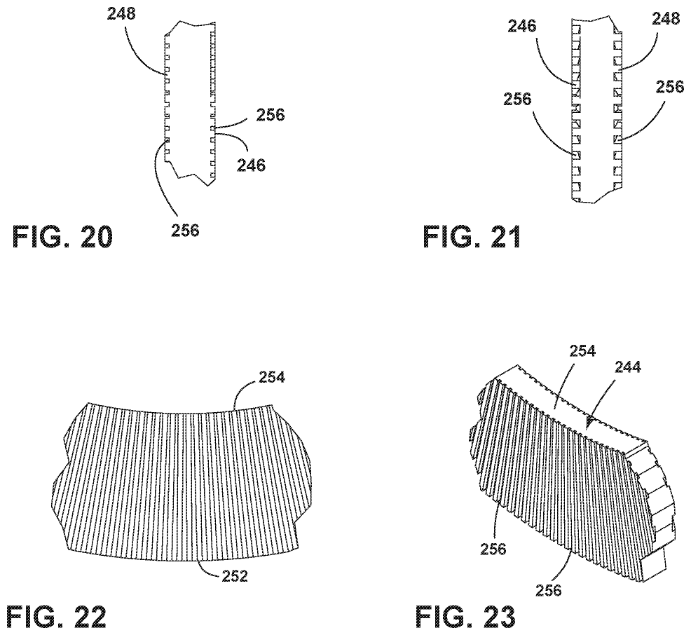

In the illustrated example, the wiggle plates 202 (FIGS. 16-23) allow liquid to escape the virtual cylinder of the wiggle plate assembly 200. Each wiggle plate 202 includes a circular disc 244 having a substantially flat first surface 246, a substantially flat second surface 248 and a central opening 250. The circular disc 244 defines an outer circular surface 252 and an inner circular surface 254 surrounding the central opening 250. Both the substantially flat first surface 246 and the substantially flat second surface 248 have a plurality of wedge shaped channels 256 extending radially from the inner circular surface 254 to the outer circular surface 252. In the illustrated example, the wedge shaped channels 256 have a substantially rectangular cross-sectional shape, but it is considered that the wedge shaped channels 256 could have other cross-sectional shapes (e.g., U-shaped with a curved bottom). The wedge shaped channels 256 have a smaller width at the inner circular surface 254 and a larger width at the outer circular surface 252. In the illustrated example, the wedge shaped channels 256 widen in a linear manner, but it is considered that the wedge shaped channels 256 could widen in a non-linear manner. The illustrated wedge shaped channels 256 have a width at the outer circular surface 252 that is twice as great as the width at the inner circular surface 254, although it is considered that other ratios could be used. The central opening 250 has a diameter substantially identical to the diameter of the central opening 238 of the mount plates 204 such that the outer end 92 of the wiper 76 can engage the inner circular surface 254 to clear the inner circular surface 254 in the same manner that the wiper 76 cleans the screen cylinder 74 of the first embodiment of the inline thickener.

During use of the third embodiment of the inline thickener, a selected portion of the liquid in the mass will pass through the wedge shaped channels 256 of the wiggle plates 202 and between the wiggle plates 202 and the adjacent mount plates 204 while the remainder of the mass will pass through the virtual cylinder of the wiggle plate assembly 200 from the elbow tube 70 to the thickened mass output 46 in the output section 56 of the liquid removal assembly 42. Each of the wiggle plates 202 are located between a pair of mount plates 204. The wiggle plates 202 are not fixed in position, but are prevented from moving radially a large amount by the elongated fasteners 218, which will abut the outer circular surface 252 of the circular disc 244 of the wiggle plates 202 when the wiggle plates 202 move radially outward. Moreover, the mount plates 204 are spaced slightly greater than the thickness of the wiggle plates 202 to allow the wiggle plates 202 to move axially between the adjacent mount plates 204. In the illustrated example, the distance between adjacent mount plates 204 is approximately 3.2% larger than the thickness of the wiggle plates 202. However, it is contemplated that other ratios could be used above and below 3.2% larger, which could be adjusted depending on the type of mass passing through the wiggle plate assembly 200.

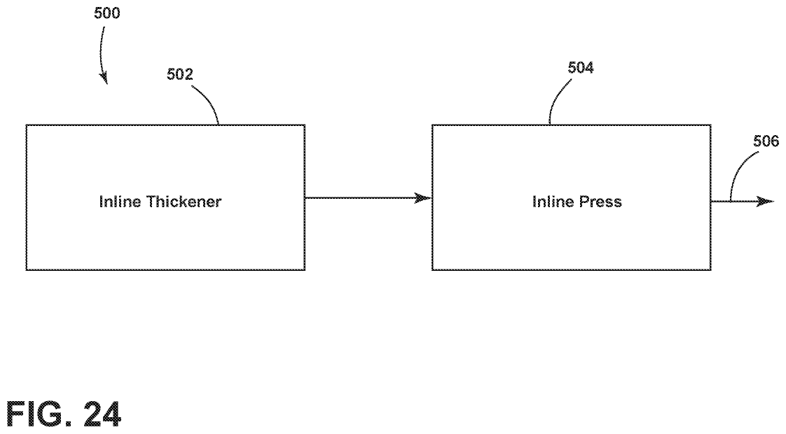

FIG. 24 illustrates an inline dewatering system 500 including an inline thickener 502 and an inline press 504. The inline thickener 502 is identical to the first, second or third embodiment of the inline thickener as outlined above. The inline press 504 is substantially identical to the first, second or third embodiment of the inline thickener as outlined above, except that the inline thickener does not include the valve 100 that is selectively opened and closed to allow the mass with the selected portion of liquid removed therefrom to pass therethrough (or the valve 100 is not used). In the inline press 504, the liquid leaving the inline press 504 is not regulated by pressure outside of the screen cylinder 74 or the wiggle plate assembly 200 (i.e., the pressure outside of the screen cylinder 74 or the wiggle plate assembly 200 is at atmospheric pressure). Therefore, in the inline dewatering system 500 of the present invention, the inline thickener 502 removes a selected portion of the liquid passing therethrough to thicken the mass and the inline press 504 removes a further portion of the liquid. In both the inline thickener 502 and the inline press 504, pressure of the mass entering the system is used to removing the liquid from the mass instead of mechanical compression of the mass. Once the mass exits the inline press 504 at exit 506, the mass can be further processed as outlined above (e.g., sent to a landfill 45).

It is to be understood that variations and modifications can be made on the aforementioned structure without departing from the concepts of the present invention. It is contemplated that the inline thickener 40 or 40a could be used in conjunction with a machine identical to the inline thickener 40 or 40a (e.g., positioned after the inline thickener 40 or 40a) except that the identical machine does not measure the amount of liquid removed from the mass and does not include any valve controlling the pressure of the liquid removed from the mass. Further, it is to be understood that such concepts are intended to be covered by the following claims unless these claims by their language expressly state otherwise.

We claim:

1. A method of removing a selected percentage of liquid from sludge while maintaining a path for the selected percentage of the liquid removed from free of blockage, the method comprising:
providing an outer housing;
providing a cylinder within the outer housing;
positioning a wiper inside the cylinder;
rotating the wiper relative to the cylinder thereby cleaning an interior surface of the cylinder;
inserting sludge under pressure into a first end of the cylinder;
forcing the sludge through an interior of the cylinder;
removing the selected percentage of liquid from the sludge passing through the cylinder;
outletting the sludge with the selected percentage of the liquid removed therefrom at a second end of the cylinder through a sludge outlet;
outletting the selected percentage of the liquid removed from the sludge through a filtrate outlet; and
constantly measuring and controlling the pressure of the sludge inlet, the sludge outlet and the filtrate outlet to control the selected percentage of the liquid in the sludge removed from the sludge during rotation of the wiper;
wherein the sludge is not mechanically compacted within the inline thickener;
the wiper including an axle and a helical fin extending from the axle, an outer edge of the helical fin scraping against the interior surface of the cylinder during rotation of the axle;
wherein the helical fin has a constant outer diameter; and
wherein the cylinder includes an interior diameter, and a diameter of the interior diameter for an entire length of the helical fin wiper is constant.

2. The method of claim 1, wherein:
the cylinder comprises a cylindrical screen.

3. The method of claim 2, wherein:
the cylindrical screen includes a plurality of slots substantially parallel to an axis of rotation of the wiper.

4. The method of claim 3, wherein:
each row of slots is interrupted.

5. The method of claim 1, wherein:
the cylinder comprises a virtual cylinder formed by openings in a plurality of fixed mount plates and a plurality of wiggle plates located between each pair of adjacent mount plates.

6. The method of claim 5, wherein:
each of the wiggle plates comprise a disc having radially extending slots on at least one surface of the disc.

7. The method of claim 6, wherein:
the slots taper and have a smaller cross-sectional area at an inner entrance and a larger cross-sectional area at an outer exit.

8. The method of claim 5, wherein:
each of the wiggle plates comprises a disc having radially extending slots on opposite surfaces of the disc.

9. The method of claim 8, wherein:
each of the slots have a pair of opposite side walls defining each slot, the pair of opposite side walls tapering toward each other such that each slot has a smaller cross-sectional area at an inner entrance and a larger cross-sectional area at an outer exit.

10. The method of claim 1, wherein:
each turn of the helical fin has the same pitch.
